(19) United States
(12) Patent Application Publication
(10) Pub. No.: US 2017/0351311 A1
(43) Pub. Date: Dec. 7, 2017

(54) POWER AWARE PACKET DISTRIBUTION

(71) Applicant: INTEL CORPORATION, Santa Clara, CA (US)

(72) Inventors: Chris MacNamara, Limerick (IE); John J. Browne, Limerick (IE)

(73) Assignee: INTEL CORPORATION, Santa Clara, CA (US)

(21) Appl. No.: 15/175,144

(22) Filed: Jun. 7, 2016

(51) Int. Cl. G06F 1/28; H04L 12/935; G06F 1/32

(52) U.S. Cl. CPC G06F 1/28; G06F 1/329; H04L 49/3018

(57) ABSTRACT

Disclosed herein is a computing device configured to implement power aware packet distribution. The computing device includes a central processing unit (CPU) comprising a plurality of cores and an interface controller communicatively coupled to the CPU. The interface controller is configured to receive a data packet to be sent to a targeted core of the plurality of cores and identify a power state of the targeted core. The interface controller is configured to redirect the data packet to an alternate core based on the power state of the targeted core.

### TECHNICAL FIELD

The present disclosure relates to packet distribution in a multiple processing core computing device. More specifically, the packet distribution techniques described herein take into account the power saving states of the cores.

### BACKGROUND ART

The central processing units (CPUs) in high performance computing devices often include multiple cores for meeting the processing workload. Additionally, power saving states have been developed to enable processors to save energy during times of reduced workload. In a multiple core CPU, the several cores can be in different power saving states at any given time.

### BRIEF DESCRIPTION OF THE DRAWINGS

FIG. 1 is a block diagram of a computing device configured to implement the power aware packet distribution techniques described herein.

FIG. 2 is a more detailed example of a NIC configured for power aware packet distribution.

FIG. 3 shows an example of a power state configuration table.

FIG. 4 is a process flow diagram of a method of performing power aware packet distribution.

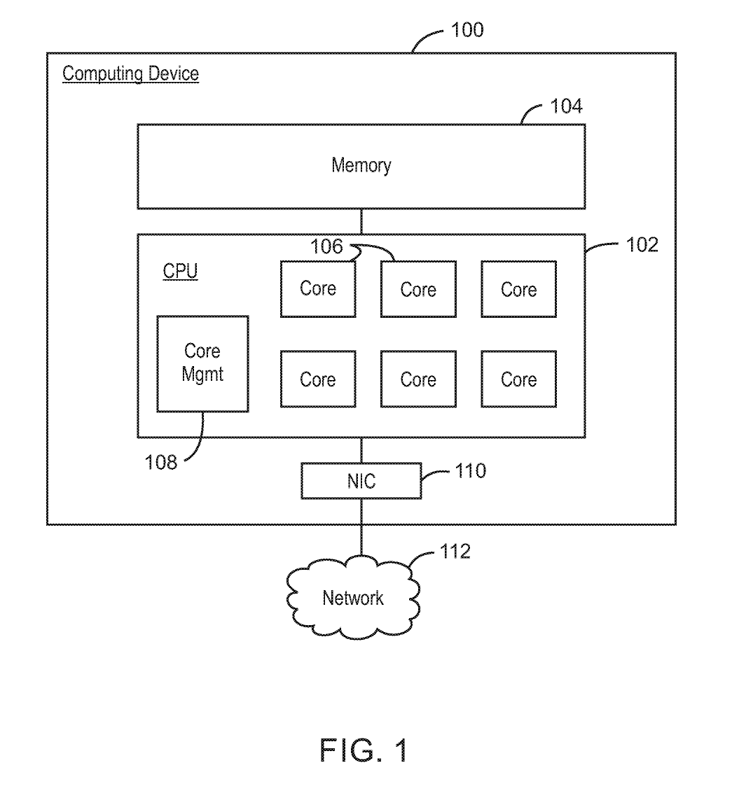

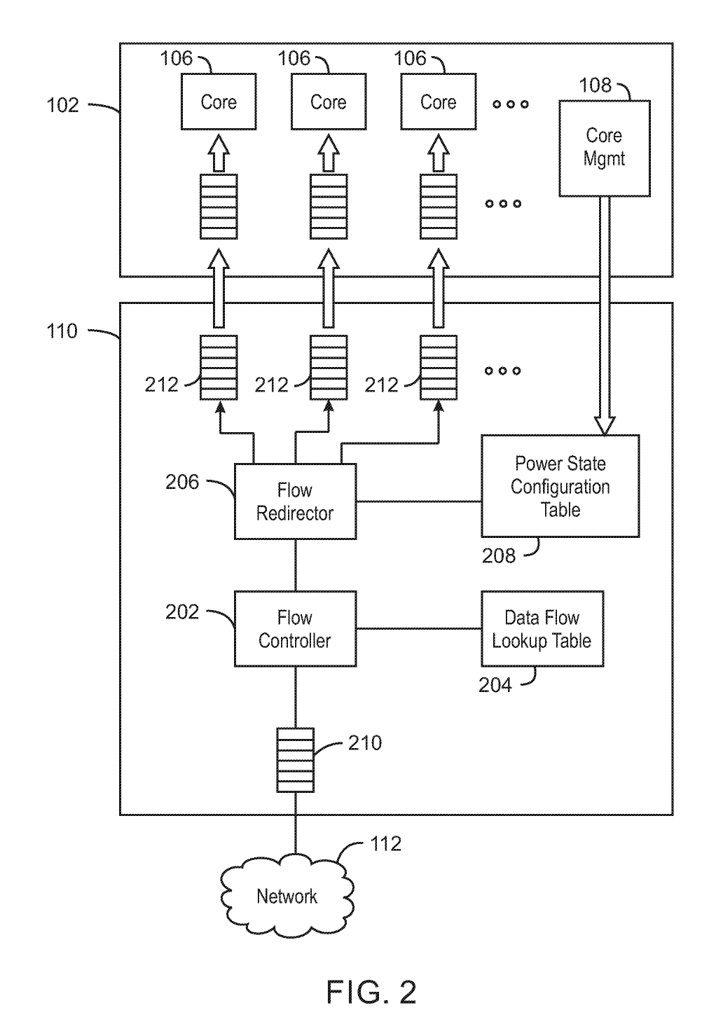

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As mentioned above, many CPUs employ power states that enable processors to save power during times of reduced workload. Such states are often referred to as P states or C states. A power state known as a Deep C state or Sleep state describes a state in which a processor is not executing instructions but is able to become active if called upon to perform a processing task. In a multiple core CPU, the power state of each core may be controlled separately. During times of reduced workload, some cores may enter a Deep C state, while other cores remain active. Active cores may be in low or high P states. C states and P states are described further below.

A typical network interface card (NIC) has a table of flows and maps flows to queues. Each queue may be dedicated to an associated processing core. Software executing in the associated core then reads packets from the queues. The present disclosure provides a decision making function that can be used to select queues based on the destination core's ability to process those packets, which is determined based on the power state of the core. Accordingly, the NIC avoids activating the scaled down or sleeping core if there is another core that is available and in a full operating state. In this way, power savings can be achieved during times of reduced workload by directing the processing workload to a smaller number of active cores, while leaving the remaining cores undisturbed and in the power saving state.

FIG. 1 is a block diagram of a computing device configured to implement the power aware packet distribution techniques described herein. The computing device 100 may be any type of computing device, such as a mobile phone, a smart phone, a laptop computer, a tablet computer, a server computer, a server blade, or a compute node of a clustered computing system, for example. The computing device 100 include a multi-core Central Processing Unit (CPU) 102 that is adapted to execute stored instructions, and a system memory 104 that stores instructions that are executable by the CPU 102. Although only one CPU 102 is shown, the computing device 100 can include two or more CPUs 102. The CPU 102 may be implemented as Complex Instruction Set Computer (CISC) or Reduced Instruction Set Computer (RISC) processors, x86 Instruction set compatible processors, or any other microprocessor.

The memory device 104 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The memory device 104 can be used to store data and computer-readable instructions that, when executed by the processor, direct the processor to perform various operations in accordance with its programming.

The CPU 102 includes multiple processing cores, which may be referred to herein as cores 106. Although six cores 106 are shown, the CPU 102 can include any suitable number of cores, including two cores, four cores, eight cores, or more. The cores 106 perform processing tasks in accordance with their programming. Each core is able to access the memory 104, which is a shared memory. Each core 106 may also have its own dedicated memory (not shown) such as cache memory.

The CPU 102 also includes a core management module 108 that controls the power states of the cores 106. The core management module 108 can command selected cores 106 to enter a power management state. As used herein, the term power state refers to a state of a core that effects the activity or processing performance of the core. The power management states can include C states, P states, S States, and others. The core management module 108 may be implemented as a logic hardware of the CPU 102, software running on the CPU 102, or other configurations. For example, the core management module 108 can also be implemented in a separate processor such as one of the cores 106.

The C states refer to the states of a core where some or all of the functions of the core are idle. Lower or deeper C states use less power and represent an idle processing state for the processor. For example, the C0 state refers to a state in which the core is fully operational, while the C1 state refers to a state where the core is not executing instructions, but can return to an executing state almost immediately. Additional C states are available depending on the design of a particular implementation. The deeper the C state, the more functions of the core will be idle, and the longer it takes to reactivate the core to a fully operational state.

The P states refer operational states of the core, meaning that the core can be doing useful work in any P-state. P states can be implemented by reducing the clock frequency and/or the voltage supply level applied to the core. Higher frequency P states provide higher performance at the cost of more power consumed. Lower frequency P states enable the core to achieve energy efficiency by reducing its power consumption and heat generation with the tradeoff that processing tasks will be processed more slowly. The cores may be configured for any suitable number of possible P states depending on the design of a particular implementation.

As used herein, the term power saving state refers to any power state that is below the fully operation power state. For example, in regard to P states, a P state below P0 (P1, P2, P3, etc.) would be considered a power saving state. With regard to C states, any C state below C0 (C1, C2, C3, etc.) would be considered a power saving state. With regard to S states, any S state below S0 (S1, S2, S3, etc.) would be considered a power saving state. The core management module 108 can command selected cores to enter a selected power saving state for a variety of reasons, such as to save power during times of reduced workload, or in response to thermal conditions, and others. In some cases one or more of the cores can be configured as a static core, meaning that the state of the core will always be maintained as full operational to meet minimum performance goals of the computing device 102. This enables the CPU 102 to react to new workloads with very low latency or service a minimum set of work.

The increased energy efficiency achieved through power scaling may have a tendency to increase latency during events such as changes in network load, including bursts of network packets. The core management module 108 has the ability to determine which cores are active and which cores are in a power saving state. Therefore, the core management module 108 can deliver packets to the active cores and steer packets away from sleeping cores, resulting in lower latency processing and no wakeup for sleeping cores. In this way, the number of cores that are maintained in an active state can be reduced and the number of cores that are placed in a power saving state can be increases, all while ensuring that the incoming packets are processed with low latency.

The computing device 100 can also include a Network Interface Controller (NIC) 110 that enables the CPU 102 to communicate with other devices through a network 112. The network 112 can be any suitable type of network, a storage area network (SAN), a Local Area Network (LAN), an Ethernet network, the Internet, and others. Data packets received by the NIC 110 are sent to the CPU 102 for processing. As described further below, a packets will often contain header information that causes the NIC 110 to direct the packet to a specific destination core. If the destination core is in a power saving state, sending the packet to the destination core will cause the core to exit the power saving state to process the packet, will result in longer latency compared to delivering to an active core. In a case in which another core was already active and able to process the packet, the destination core will be reactivated needlessly, resulting in reduced power efficiency.

The NIC 110 in accordance with the present techniques is able to determine the power states of the cores and redirect the packet accordingly. If the destination core is in a power saving state and another core is active and able to process the packet, the NIC 110 will redirect the packet to the active core, which allows the destination core to remain in the power saving state while also reducing the latency for the processing of the packet. An example technique for redirecting packets is described further in relation to FIGS. 2-4.

It is to be understood that the block diagram of FIG. 1 is not intended to indicate that the electronic device 100 is to include all of the components shown in FIG. 1. Rather, the electronic device 100 can include fewer or additional components not illustrated in FIG. 1. For example, the computing device can include additional NICs, a memory controller, a graphics processing unit, and additional Input/Output (I/O interfaces). Furthermore, although the present techniques are described in relation to a NIC, the techniques can be implemented in any device that communicates with the CPU 102, including a graphics processing unit, peripheral components, and others. The techniques can also be used in core-to-core communications.

FIG. 2 is a more detailed example of a NIC configured for power aware packet distribution. The example NIC 110 shown in FIG. 2 includes a flow controller 202, data flow lookup table 204, flow redirector 206, and power state configuration table 208. The use of separate boxes for the flow controller 202 and the flow redirector 206 is not intended to indicate that the flow controller 202 and the flow redirector 206 are necessarily separate hardware components. Rather, the flow controller 202 and the flow redirector 206 can be different programming tasks implemented by a single processor.

Packets received from the network 112 may be received at an input buffer 210 and read out of the input buffer 210 by the flow controller 202. The flow controller 202 can parse the header information of an individual packet to identify a source of the packet. This parsed data may then be applied to the data flow lookup table 204 to identify a corresponding queue, which is identified as the targeted queue. The flow controller 202 can implement Receive-Side Scaling (RSS) and other methods. In some examples, the flow controller 202 implements a hashing function, which pins specific IP address to specific cores 106.

After the targeted queue is identified, the flow redirector 206 accesses the power state configuration table 208 to determine the power states of the cores. In the power state configuration table 208, each targeted queue is mapped to a number of alternative destination queues 212, which are the physical queues included in the NIC 110. Each destination queue 212 is associated with a specific core 106. The power state configuration table 208 can identify the current power state of the core 106 associated with each destination queue 212, such as whether the core 106 is in a power saving state. The flow redirector 206 is then able to use this information to direct the packet to a suitable destination queue 212 based on the power states of the cores 106. For example, if one of the destination queues 212 is associated with an active core 106, and one of the destination queues 212 is associated with a core that is currently in a power saving state, the flow redirector 206 will direct the packet to the destination queues 212 is associated with an active core 106. In this way, the NIC 110 can direct traffic away from the power scaling cores and keeping them in power saving states.

As the power states change for each core 100, the power state configuration table 208 may be updated to reflect the new configuration. The power state configuration table 208 may be updated by software running on the CPU 102 or a hardware mechanism. An example of a hardware mechanism includes hardware for sensing changes in the CPU power registers, for example, C state or P state enable registers. The power state configuration table 208 can also be updated by the core management module 108.

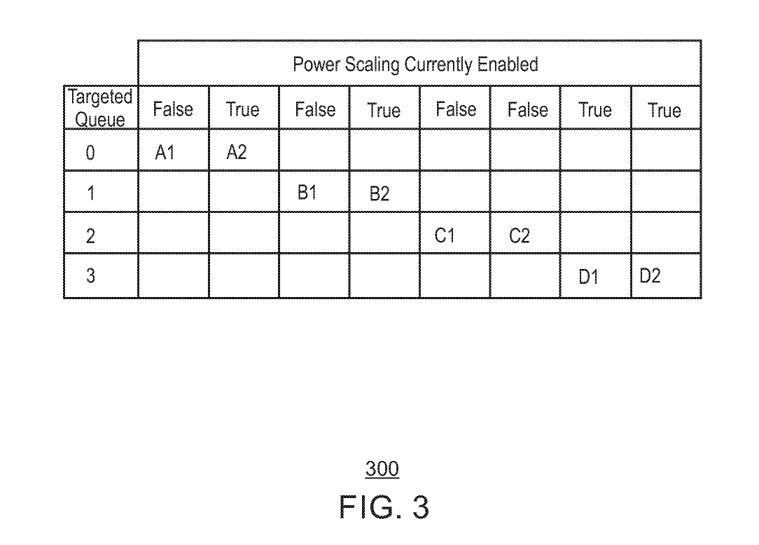

FIG. 3 shows an example of a power state configuration table. The power state configuration table 300 may be stored to a memory device included in or available to the NIC 110, and is used to enable the flow redirector 206 to direct traffic away from cores 106 that are in a power saving state. The left hand column of the table shows the targeted queues, which are numbered 1 through 4 in this example. The targeted queues are the queues that are identified by the flow controller 202 and may not be actual physical queues. For example, the targeted queues may be a logical construct that enables the packets to be mapped to alternate destinations. Furthermore, although four targeted queues are shown, any suitable number of queues may be included in the table.

The table entries to the right of each targeted queue identify the alternative destination queues that can handle those packets targeted to the targeted queue. For example, packets targeted to queue 0 can be handled by destination queue A1 and A2, packets targeted to queue 1 can be handled by destination queue B1 and B2, and so on. Although two destination queues are shown for each targeted queue, each targeted queue can be mapped to more than two destination queues. In some examples, the alternative queues may be disabled to provide legacy support, in which case the targeted queue is selected.

The entries in the top row indicate the power scaling mode associated with the destination queue, which is the power state of the core associated with the corresponding destination queue. In some examples, the power scaling mode may be a Boolean value that indicates simply whether the core is fully active or is in some power saving state (below C0 or P0, for example). For example, the core associated with destination queue A1 is identified as not being in a power saving state (power scaling currently enabled=False), the core associated with destination queue A2 is identified as being in a power saving state (power scaling currently enabled=True), and so on. In the current configuration, any packet targeting queue 0 would be redirected to queue A1 to avoid waking the core associated with queue A2 from the power saving state.

Other configurations are also possible. In some examples, the power scaling mode may be used to indicate whether the corresponding core is in a specific power saving state below a certain threshold, such as C2 or P2, for example. In this case, traffic would be directed away from cores if the power state is C2 or below, but not if the power state is C0 or C1.

In some examples, the power scaling mode may also be used to indicate the specific power state for each core. In this case, packets could be targeted to the cores with the most active power states. For example, if the power scaling mode of one of the destination queues indicates a C2 state and the power scaling mode of the other possible destination queue indicates a C3 state, the packet can be redirected to the core that is in the C2 state. Various other possible implementations are also possible.

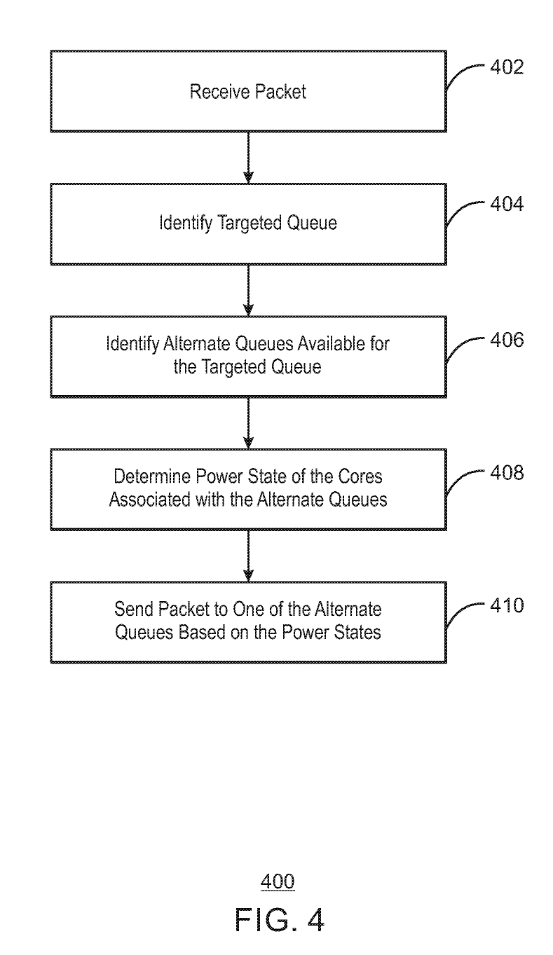

FIG. 4 is a process flow diagram of a method of performing power aware packet distribution. The method 400 may be performed by the thermal management unit 116 and the memory controller 106. It will be understood that the method described herein can include fewer or additional actions. Furthermore, the method 600 should not be interpreted as implying that the actions have to be performed in any specific order.

At block 402, a data packet is received. The received data packet may be directed to a particular core of a multicore processor.

At block 404, a targeted queue is identified. The targeted queue may be identified based on information in the data packet. For example, the data packet may include an address, such as a MAC address, which is associate with a particular queue. The queue associated with the address may be referred to as the targeted queue. The targeted queue is associated with two or more alternate queues, which are the actual physical queues that the packet can be sent to. Each of the alternate queues is associated with a specific core of a central processing unit (CPU).

At block 406, alternate queues available for the targeted queue are identified. The alternate queues may be identified by looking up the targeted queue in a lookup table, such as the power state configuration table described above.

At block 408, power states are determined for the cores associated with the alternate queues. The power states may be obtained by looking up the power state in the power state configuration table.

At block 410, the data packet is sent to one of the alternate queues based on the power states. For example, the data packet may be sent to the alternate queue associated with a core that is not in a power saving state. If both alternate queues are associated with cores that are in power saving states, then the data packet may be sent to the most active core and redirected away from the power core that is in the deeper power saving state. For example, if a first core is in a P1 state and second core is in a deeper P3 state, the data packet will be sent to the alternate queue associated with the first core. Similarly, if a first core is in a C1 state and second core is in a deeper C3 state, the data packet will be sent to the alternate queue associated with the first core.

The method may be repeated for each received packet. It is to be understood that the process flow diagram of FIG. 4 is not intended to indicate that the blocks of the method 400 are to be executed in any particular order, or that all of the blocks are to be included in every case. Further, any number of additional blocks may be included within the method 400, depending on the specific implementation.

### EXAMPLES

Example 1 is a computing device with power aware packet distribution. The computing device includes a central processing unit (CPU) including a plurality of cores; and an interface controller communicatively coupled to the CPU. The interface controller is configured to: receive a data packet to be sent to a targeted core of the plurality of cores; identify a power state of the targeted core; and redirect the data packet to an alternate core based on the power state of the targeted core.

Example 2 includes the computing device of example 1, including or excluding optional features. In this example, the interface controller includes a power state configuration table, wherein information to be stored to the power state configuration table identifies power states of each of the plurality of cores. Optionally, the information in the power state configuration table is maintained by the CPU. Optionally, the interface controller includes a flow redirector that identifies the power state of the targeted core by accessing the power state configuration table. Optionally, the power state configuration table identifies the alternate core that can accept the data packet.

Example 3 includes the computing device of any one of examples 1 to 2, including or excluding optional features. In this example, the targeted core is associated with a targeted queue, wherein to redirect the data packet to an alternate core based on the power state, the interface controller is to identify a first alternate queue associated with the targeted queue and a second alternate queue associated with the targeted queue. Optionally, the interface controller is to send the data packet to the first alternate queue or the second alternate queue depending, at least in part, on a first power state associated with the first alternate queue. Optionally, the interface controller includes: a flow controller that identifies the targeted queue based on information contained in the data packet; and a flow redirector that identifies alternate queues associated with the targeted queue.

Example 4 includes the computing device of any one of examples 1 to 3, including or excluding optional features. In this example, the power state is a P state.

Example 5 includes the computing device of any one of examples 1 to 4, including or excluding optional features. In this example, the power state is a C state.

Example 6 is an interface controller with power aware packet distribution. The interface controller is configured to receive a data packet to be sent to a targeted core of a plurality of cores of a central processing unit (CPU); identify a power state of the targeted core; and redirect the data packet to an alternate core of the plurality of cores based on the power state of the targeted core.

Example 7 includes the interface controller of example 6, including or excluding optional features. In this example, the interface controller includes a power state configuration table, wherein information to be stored to the power state configuration table identifies power states of each of the plurality of cores. Optionally, the information in the power state configuration table is maintained by the CPU. Optionally, the interface controller includes a flow redirector that identifies the power state of the targeted core by accessing the power state configuration table. Optionally, the power state configuration table identifies the alternate core that can accept the data packet.

Example 8 includes the interface controller of any one of examples 6 to 7, including or excluding optional features. In this example, the targeted core is associated with a targeted queue, and to redirect the data packet to an alternate core based on the power state, the interface controller is to identify a first alternate queue associated with the targeted queue and a second alternate queue associated with the targeted queue. Optionally, the interface controller includes logic to send the data packet to the first alternate queue or the second alternate queue depending, at least in part, on a first power state associated with the first alternate queue. Optionally, the interface controller includes: a flow controller that identifies the targeted queue based on information contained in the data packet; and a flow redirector that identifies alternate queues associated with the targeted queue.

Example 9 includes the interface controller of any one of examples 6 to 8, including or excluding optional features. In this example, the power state is a P state.

Example 10 includes the interface controller of any one of examples 6 to 9, including or excluding optional features. In this example, the power state is a C state.

Example 11 is a method of distributing packets to cores of a central processing unit (CPU) based in part on the power states of the cores. The method includes receiving a data packet to be sent to a targeted queue, wherein the targeted queue is associated with two or more alternate queues, and wherein each of the two or more alternate queues is associated with a core of a central processing unit (CPU). The method also includes identifying the two or more alternate queues; identifying a power state of the core associated with each alternative queue; and sending the data packet to one of the two or more alternate queues based on the power states.

Example 12 includes the method of example 11, including or excluding optional features. In this example, identifying the power state of the core associated with each alternative queue includes looking up the power state in a power state configuration table. Optionally, the power state configuration table is maintained by the CPU. Optionally, identifying the two or more alternate queues includes looking up the targeted queue in the power state configuration table.

Example 13 includes the method of any one of examples 11 to 12, including or excluding optional features. In this example, sending the data packet to one of the two or more alternate queues based on the power states includes sending the data packet to the alternate queue that is not in a power saving state.

Example 14 includes the method of any one of examples 11 to 13, including or excluding optional features. In this example, sending the data packet to one of the two or more alternate queues based on the power states includes sending the data packet to the alternate queue that is in a more active power saving state.

Example 15 includes the method of any one of examples 11 to 14, including or excluding optional features. In this example, the method includes sending the data packet to the first alternate queue or the second alternate queue depending, at least in part, on a first power state associated with the first alternate queue.

Example 16 includes the method of any one of examples 11 to 15, including or excluding optional features. In this example, the method includes identifying the targeted queue based on information contained in the data packet.

Example 17 includes the method of any one of examples 11 to 16, including or excluding optional features. In this example, the power state is a P state.

Example 18 includes the method of any one of examples 11 to 17, including or excluding optional features. In this example, the power state is a C state.

Example 19 is a non-transitory computer-readable medium. The computer-readable medium includes instructions that direct the processor to receive a data packet to be sent to a targeted queue, wherein the targeted queue is associated with two or more alternate queues, and wherein each of the two or more alternate queues is associated with a core of a central processing unit (CPU). The computer-readable medium also includes instructions that direct the processor to identify the two or more alternate queues; identify a power state of the core associated with each alternative queue; and send the data packet to one of the two or more alternate queues based on the power states.

Example 20 includes the computer-readable medium of example 19, including or excluding optional features. In this example, the instructions to identify the power state of the core associated with each alternative queue include instructions that direct the processor to look up the power state in a power state configuration table. Optionally, the power state configuration table is maintained by the CPU. Optionally, the instructions to identify the two or more alternate queues include instructions that direct the processor to look up the targeted queue in the power state configuration table.

Example 21 includes the computer-readable medium of any one of examples 19 to 20, including or excluding optional features. In this example, the instructions to send the data packet to one of the two or more alternate queues based on the power states includes instructions to send the data packet to the alternate queue that is not in a power saving state.

Example 22 includes the computer-readable medium of any one of examples 19 to 21, including or excluding optional features. In this example, the instructions to send the data packet to one of the two or more alternate queues based on the power states includes instructions to send the data packet to the alternate queue that is in a more active power saving state.

Example 23 includes the computer-readable medium of any one of examples 19 to 22, including or excluding optional features. In this example, the computer-readable medium includes instructions to send the data packet to the first alternate queue or the second alternate queue depending, at least in part, on a first power state associated with the first alternate queue.

Example 24 includes the computer-readable medium of any one of examples 19 to 23, including or excluding optional features. In this example, the computer-readable medium includes instructions to identify the targeted queue based on information contained in the data packet.

Example 25 includes the computer-readable medium of any one of examples 19 to 24, including or excluding optional features. In this example, the power state is a P state.

Example 26 includes the computer-readable medium of any one of examples 19 to 25, including or excluding optional features. In this example, the power state is a C state.

Example 27 is an apparatus with power aware packet distribution. The apparatus includes means for receiving a data packet to be sent to a targeted queue, wherein the targeted queue is associated with two or more alternate queues, and wherein each of the two or more alternate queues is associated with a core of a central processing unit (CPU). The apparatus also includes means for identifying the two or more alternate queues; means for identifying a power state of the core associated with each alternative queue; and means for sending the data packet to one of the two or more alternate queues based on the power states.

Example 28 includes the apparatus of example 27, including or excluding optional features. In this example, the means for identifying the power state of the core associated with each alternative queue includes means for looking up the power state in a power state configuration table. Optionally, the power state configuration table is maintained by the CPU. Optionally, the means for identifying the two or more alternate queues includes the means for looking up the targeted queue in the power state configuration table.

Example 29 includes the apparatus of any one of examples 27 to 28, including or excluding optional features. In this example, the means for sending the data packet to one of the two or more alternate queues based on the power states includes means for sending the data packet to the alternate queue that is not in a power saving state.

Example 30 includes the apparatus of any one of examples 27 to 29, including or excluding optional features. In this example, the means for sending the data packet to one of the two or more alternate queues based on the power states includes means for sending the data packet to the alternate queue that is in a more active power saving state.

Example 31 includes the apparatus of any one of examples 27 to 30, including or excluding optional features. In this example, the apparatus includes means for sending the data packet to the first alternate queue or the second alternate queue depending, at least in part, on a first power state associated with the first alternate queue.

Example 32 includes the apparatus of any one of examples 27 to 31, including or excluding optional features. In this example, the apparatus includes means for identifying the targeted queue based on information contained in the data packet.

Example 33 includes the apparatus of any one of examples 27 to 32, including or excluding optional features. In this example, the power state is a P state.

Example 34 includes the apparatus of any one of examples 27 to 33,including or excluding optional features. In this example, the power state is a C state.

In the above description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a computer-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, described herein. The various appearances “an embodiment,” “one embodiment,” or “some embodiments” are not necessarily all referring to the same embodiments.

Not all components, features, structures, or characteristics described and illustrated herein are to be included in a particular embodiment or embodiments in every case. If the specification states a component, feature, structure, or characteristic “may”, “might”, “can” or “could” be included, for example, that particular component, feature, structure, or characteristic may not be included in every case. If the specification or claims refer to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein may not be arranged in the particular way illustrated and described herein. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A computing device, comprising:
a central processing unit (CPU) comprising a plurality of cores;
an interface controller communicatively coupled to the CPU, the interface controller to:
receive a data packet to be sent to a targeted core of the plurality of cores;
identify a power state of the targeted core; and
redirect the data packet to an alternate core based on the power state of the targeted core.

2. The computing device of claim 1, wherein the interface controller comprises a power state configuration table, wherein information to be stored to the power state configuration table identifies power states of each of the plurality of cores.

3. The computing device of claim 2, wherein the information in the power state configuration table is maintained by the CPU.

4. The computing device of claim 2, wherein the interface controller comprises a flow redirector that identifies the power state of the targeted core by accessing the power state configuration table.

5. The computing device of claim 2, wherein the power state configuration table identifies the alternate core that can accept the data packet.

6. The computing device of claim 1, wherein the targeted core is associated with a targeted queue, wherein to redirect the data packet to an alternate core based on the power state, the interface controller is to identify a first alternate queue associated with the targeted queue and a second alternate queue associated with the targeted queue.

7. The computing device of claim 6, wherein the interface controller is to send the data packet to the first alternate queue or the second alternate queue depending, at least in part, on a first power state associated with the first alternate queue.

8. The computing device of claim 6, wherein the interface controller comprises:
a flow controller that identifies the targeted queue based on information contained in the data packet; and
a flow redirector that identifies alternate queues associated with the targeted queue.

9. The computing device of claim 1, wherein the power state is a P state.

10. The computing device of claim 1, wherein the power state is a C state.

11. An interface controller comprising logic to:
receive a data packet to be sent to a targeted core of a plurality of cores of a central processing unit (CPU);
identify a power state of the targeted core; and
redirect the data packet to an alternate core of the plurality of cores based on the power state of the targeted core.

12. The interface controller of claim 11, comprising a power state configuration table, wherein information to be stored to the power state configuration table identifies power states of each of the plurality of cores.

13. The interface controller of claim 12, wherein the information in the power state configuration table is maintained by the CPU.

14. The interface controller of claim 12, comprising a flow redirector that identifies the power state of the targeted core by accessing the power state configuration table.

15. The interface controller of claim 12, wherein the power state configuration table identifies the alternate core that can accept the data packet.

16. The interface controller of claim 11, wherein the targeted core is associated with a targeted queue, and to redirect the data packet to an alternate core based on the power state, the interface controller is to identify a first alternate queue associated with the targeted queue and a second alternate queue associated with the targeted queue.

17. The interface controller of claim 16, comprising logic to send the data packet to the first alternate queue or the second alternate queue depending, at least in part, on a first power state associated with the first alternate queue.

18. The interface controller of claim 16, wherein the interface controller comprises:
a flow controller that identifies the targeted queue based on information contained in the data packet; and
a flow redirector that identifies alternate queues associated with the targeted queue.

19. The interface controller of claim 11, wherein the power state is a P state.

20. The interface controller of claim 11, wherein the power state is a C state.

21. A method, comprising:
receiving a data packet to be sent to a targeted queue, wherein the targeted queue is associated with two or more alternate queues, and wherein each of the two or more alternate queues is associated with a core of a central processing unit (CPU);
identifying the two or more alternate queues;
identifying a power state of the core associated with each alternative queue; and
sending the data packet to one of the two or more alternate queues based on the power states.

22. The method of claim 21, wherein identifying the power state of the core associated with each alternative queue comprises looking up the power state in a power state configuration table.

23. The method of claim 22, wherein the power state configuration table is maintained by the CPU.

24. The method of claim 22, wherein identifying the two or more alternate queues comprises looking up the targeted queue in the power state configuration table.

25. The method of claim 21, wherein sending the data packet to one of the two or more alternate queues based on the power states comprises sending the data packet to the alternate queue that is not in a power saving state.
